(19) United States
(12) Patent Application Publication
(10) Pub. No.: US 2020/0045581 A1
(43) Pub. Date: Feb. 6, 2020

(54) CARRIER AGGREGATION MANAGEMENT FOR DUAL-CONNECTIVITY WIRELESS ACCESS

(71) Applicant: Verizon Patent and Licensing Inc., Arlington, VA (US)

(72) Inventors: Yuexin Dong, Bridgewater, NJ (US); Jignesh S. Panchal, Hillsborough, NJ (US)

(21) Appl. No.: 16/055,542

(22) Filed: Aug. 6, 2018

(51) Int. Cl. H04W 28/06; H04W 28/02; H04W 76/15; H04W 88/16

(52) U.S. Cl. CPC H04W 28/065; H04W 28/0278; H04L 5/001; H04W 88/16; H04W 76/15

(57) ABSTRACT

Systems and methods described herein enable optimizing carrier aggregation over a dual-connectivity bearer. A wireless station determines a buffer size for an end device connected to the wireless station via a wireless communication interface. The buffer size reflects a service requirement for the end device. The wireless station determines, for the end device and based on the buffer size, an optimal carrier aggregation combination to satisfy a service requirement for the end device, wherein the optimal carrier aggregation combination is selected from a dynamic list of component carriers for different radio access technology (RAT) types that are available to end devices serviced by the wireless station; and sends, to the end device, instructions to implement the carrier aggregation combination.

### BACKGROUND

Dual connectivity solutions may be employed when user equipment (UE) can connect to different Radio Access Technology (RAT) types simultaneously. For example, a UE may want to simultaneously connect to a Long Term Evolution (LTE) network and a Next Generation mobile network for a specific bearer.

LTE is a mobile telecommunications standard for wireless communication involving mobile user equipment, such as mobile devices and data terminals. LTE networks include existing Fourth Generation (4G), and 4.5 Generation (4.5G) wireless networks. Next Generation mobile networks, such as Fifth Generation (5G) mobile networks, have been proposed as the next evolution of mobile wireless networks. Next Generation mobile networks are designed to increase data transfer rates, increase spectral efficiency, improve coverage, improve capacity, and reduce latency. The proposed 5G mobile telecommunications standard, among other features, may operate in the millimeter wave bands (e.g., 28, 38, and 60 Gigahertz (GHz)) as well as other frequency bands (e.g., >6 GHz).

### BRIEF DESCRIPTION OF THE DRAWINGS

FIG. 1 is a diagram illustrating a network environment according to an implementation described herein;

FIG. 2 is a diagram illustrating connections among devices in an exemplary portion of the network environment of FIG. 1;

FIG. 3 is a diagram of exemplary components that may be included in one or more of the devices shown in FIGS. 1 and 2;

FIG. 4 is a block diagram of exemplary logical components of one of the wireless stations of FIG. 1;

FIG. 5 is a diagram illustrating an exemplary portion of carrier aggregation combinations from FIG. 4;

FIG. 6 is an exemplary logic chart showing how carrier aggregation combinations may be assigned by a wireless station, according to an implementation described herein;

FIG. 7 is a flow diagram illustrating an exemplary process for optimizing carrier aggregation over a dual-connectivity bearer, according to an implementation described herein; and

FIGS. 8A and 8B are a diagram illustrating exemplary communications for managing carrier aggregation in a dual connectivity environment, according to an implementation described herein.

### DETAILED DESCRIPTION OF THE PREFERRED EMBODIMENTS

The following detailed description refers to the accompanying drawings. The same reference numbers in different drawings may identify the same or similar elements.

With development of future generation radio technologies, such as Fifth Generation New Radio (5G NR), user equipment (UE, also referred to herein as an “end device”) can connect simultaneously to a 5G NR radio access network (RAN) and an Evolved Universal Mobile Telecommunications System (UMTS) Terrestrial Radio Access Network (E-UTRAN) of a Long Term Evolution (LTE) network for a specific bearer. In a multi-RAT (e.g., E-UTRA-NR Dual Connectivity (EN-DC)) environment, downlink and uplink packets can be transmitted over either/both of the radio access technologies. Thus, the wireless access portion of the bearer (e.g., a logical channel with particular end-to-end quality of service (QoS) requirements) may be split among different types of access networks.

Carrier aggregation is a fundamental function in 5G NR and LTE-Advanced (LTE-A) RANs to enable very high throughput. Carrier aggregation may be used to increase bandwidth by using multiple downlink or uplink communication channels, referred to as component carriers. Carrier aggregation may increase peak and average throughput on a shared channel by aggregating two or more carriers' bandwidths and thus increasing effective bandwidth. As an example, component carriers for LTE may provide effective bandwidth up to about a hundred megabits-per-second (Mbps), while component carriers for 5G NR may provide effective bandwidths approaching about one gigabit-per-second (Gbps). The aggregated carrier number (e.g., the number of active component carriers) is typically limited by an end device's capability.

Though the higher bandwidths made possible by 5G NR and carrier aggregation can provide improved user experiences, there can be detrimental impacts to end device performance when these technologies are used. For example, additional transmit power for acknowledgements, increased code rates, and increased state reporting associated with carrier aggregation and/or 5G NR can lead to increased battery consumption at the end device. Thus, due to power saving requirements for the end device, it is not desirable to have all available component carriers active all the time. Wider component carrier bandwidth and more component carriers are not preferred from an end device power saving perspective.

Systems and methods described herein allow the network to select an optimal combination of carrier aggregation and RAT selection to support a particular service requirement in dual-connectivity scenarios. For example, when an end device requires very high downlink speeds, all 5G NR component carriers and all LTE component carriers available to the end device can be aggregated to achieve peak throughput. Conversely, if one or more LTE component carriers can satisfy a service speed demand, the end device may use only the LTE carriers, even when the end device is in a 5G NR coverage area. Additionally, systems and methods described herein may adjust carrier aggregation combinations (e.g., to less processing-intensive carrier aggregation combinations) to compensate for poor end device battery conditions (e.g., low battery levels, overheating, etc.). As used herein, an “optimal” carrier aggregation combination may be a combination of component carriers (from one or more RAT types) that meets service requirements for the end device while minimizing assigned bandwidth and/or end device battery consumption. Service requirements for the end devices may be estimated based on buffer sizes established for the end device to match a service request. Thus, carrier aggregation combinations may be selected initially by a wireless station without the latency of “ramping up” to a maximum bandwidth when adding component carriers one-by-one.

According one implementation, a wireless station may determine a buffer size for an end device connected to the wireless station via a wireless communication interface. The determined buffer size may reflect a service requirement for the end device (e.g., streaming bandwidth, latency, etc., associated with an application). The wireless station may determine, for the end device and based on the determined buffer size, an optimal carrier aggregation combination to satisfy a service requirement for the end device, wherein the optimal carrier aggregation combination is selected from a dynamic list of component carriers for different radio access technology (RAT) types that are available to end devices serviced by the wireless station. The wireless station may send to the end device, instructions to implement the carrier aggregation combination.

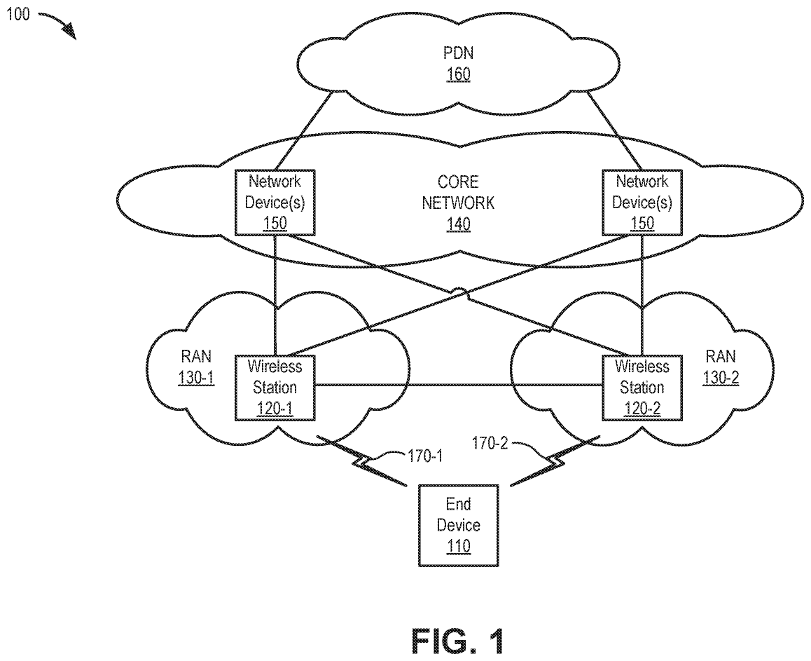

FIG. 1 is a diagram of an exemplary environment 100 in which the systems and/or methods, described herein, may be implemented. As shown in FIG. 1, environment 100 may include an end device 110, a wireless station 120-1 for one type of RAN 130-1, a wireless station 120-2 for a different type of RAN 130-2, a core network 140 with network devices 150, and a packet data network (PDN) 160. Wireless stations 120-1 and 120-2 may be referred to herein collectively as wireless stations 120 and generically as wireless station 120, and RAN 130-1 and RAN 130-2 may be referred to herein collectively as RANs 130 and generically as RAN 130. According to other embodiments, environment 100 may include additional networks, fewer networks, and/or different types of networks than those illustrated and described herein.

Environment 100 includes links between the networks and between the devices. Environment 100 may be implemented to include wired, optical, and/or wireless links among the devices and the networks illustrated. A communicative connection via a link may be direct or indirect. For example, an indirect communicative connection may involve an intermediary device and/or an intermediary network not illustrated in FIG. 1. Additionally, the number and the arrangement of links illustrated in environment 100 are exemplary.

In the configuration of FIG. 1, end device 110 may use wireless channels 170-1 and 170-2 (referred to collectively as wireless channels 170) to access wireless stations 120-1 and 120-2, respectively. Wireless channels 170 may correspond, for example, to physical layer protocols in accordance with different RAT types. For example, wireless channel 170-1 may correspond to physical layer protocols for 4G or 4.5G RAN standards (e.g., 3GPP standards for 4G and 4.5G air interfaces, collectively referred to herein as “4G”), while wireless channel 170-2 may correspond to physical layer protocols for 5G New Radio standards (e.g., 3GPP standards for 5G air interfaces). As described further herein, wireless channels 170 may be used to provide communications to/from end device 110 using a dual-connectivity split bearer.

End device 110 may include any type of mobile device having multiple coverage mode capabilities, and thus communicate simultaneously with different wireless stations (e.g., wireless stations 120) using different wireless channels (e.g., channels 170) corresponding to the different RANs (e.g., RANs 130). End device 110 may further support carrier aggregation over one or both of wireless channels 170. End device 110 may be a mobile device that may include, for example, a cellular radiotelephone, a smart phone, a tablet, any type of internet protocol (IP) communications device, a Voice over Internet Protocol (VoIP) device, a laptop computer, a wearable computer, a gaming device, a media player device, or a digital camera that includes communication capabilities (e.g., wireless communication mechanisms such as Wi-Fi). In other implementation, end device 110 may be implemented as a machine-type communications (MTC) device, an Internet of Things (IoT) device, a machine-to-machine (M2M) device, etc.

According to implementations described herein, end device 110 may be provisioned (e.g., via a subscriber identity module (SIM) card or another secure element) to recognize particular network identifiers (e.g., associated with RANs 130) and to support particular RF spectrum ranges. Additionally, end device 110 may support simultaneous carrier aggregation of different RAT types (e.g., 4G and 5G NR). End device 110 may report an uplink (UL) buffer size to a wireless station 120 (e.g., as part of a service request or Radio Resource Control (RRC) signaling).

Wireless station 120 may include a network device that has computational and wireless communication capabilities. Wireless station 120 may include a transceiver system that connects end device 110 to other components of RAN 130 and core network 140 using wireless/wired interfaces. Wireless station 120 may be implemented as a base station (BS), a base transceiver station (BTS), a Node B, an evolved Node B (eNB), an evolved LTE (eLTE) eNB, a next generation Node B (gNB), a remote radio head (RRH), an RRH and a baseband unit (BBU), a BBU, or other type of wireless node (e.g., a picocell node, a femtocell node, a microcell node, etc.) that provides wireless access to one of RANs 130. Each wireless station 120 may support a RAN 130 having different RAT-types. For example, in one implementation, RAN 130-1 may include an E-UTRAN for an LTE network, while RAN 130-2 may include a 5G NR RAN.

According to an exemplary embodiment, one of wireless stations 120 includes logic that selects a combination of carrier aggregation and RAT types to support a particular service requirement while meeting power saving needs of end device 110. More particularly, wireless station 120 will match the end-device buffer size (e.g., obtained via communication with end device 110, traffic flow properties, etc.) to the bandwidth of available carrier aggregation combinations from both RAT-types (e.g., associated with wireless channels 170-1 and 170-2).

Core network 140 may include one or multiple networks of one or multiple types. For example, core network 140 may be implemented to include a terrestrial network and/or a satellite network. According to an exemplary implementation, core network 140 includes a complementary network pertaining to multiple RANs 130. For example, core network 140 may include the core part of an LTE network, an LTE-A network, a 5G network, a legacy network, and so forth.

Depending on the implementation, core network 140 may include various network elements that may be implemented in network devices 150. Such network elements may include a mobility management entity (MME), a user plane function (UPF), a session management function (SMF), a core access and mobility management function (AMF), a unified data management (UDM), a PDN gateway (PGW), a serving gateway (SGW), a policy control function (PCF), a home subscriber server (HSS), as well other network elements pertaining to various network-related functions, such as billing, security, authentication and authorization, network polices, subscriber profiles, network slicing, and/or other network elements that facilitate the operation of core network 140. In some implementations, one or network devices 150 may provide information to wireless stations 120 to facilitate optimizing carrier aggregation in a dual-connectivity environment.

PDN 160 may include one or more networks, such as a local area network (LAN), a wide area network (WAN), a metropolitan area network (MAN), a telephone network, the Internet, etc., capable of communicating with end devices 110. In one implementation, PDN 160 includes a network that provides data services (e.g., via packets or any other Internet protocol (IP) datagrams) to end device 110.

The number and arrangement of devices in environment 100 are exemplary. According to other embodiments, environment 100 may include additional devices and/or differently arranged devices, than those illustrated in FIG. 1.

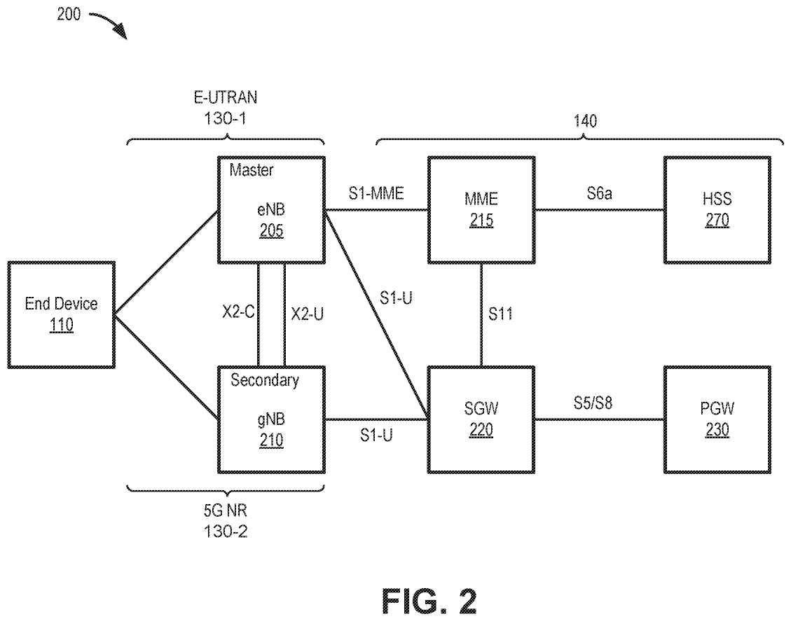

FIG. 2 is a diagram illustrating connections among devices in an exemplary portion 200 of network environment 100. In the configuration of FIG. 2, dual connectivity capability is provided to end device 110 using E-UTRAN 130-1 and 5G NR RAN 130-2. Wireless stations 120-1 and 120-2 for RANs 130-1 and 130-2 may be implemented as eNB 205 and gNB 210, respectively. Core network 140 may include network elements of an Evolved Packet Core (EPC, also referred to as 4G core). As shown in FIG. 2, core network 140 may include an MME 215 device, an SGW device 220, a PGW device 230, and an HSS device 270. In other implementations, core network 140 may include network elements associated with a 4.5G core or a 5G core.

eNB 205 may include one or more devices and other components having functionality that allow end device 110 to wirelessly connect to RAN 130-1. eNB 205 may interface with core network 140 via an S1 interface, which may be split into a control plane S1-MME interface and a user plane S1-U interface. S1-MME interface may provide an interface between eNB 205 and MME device 215. The S1-U interface may provide an interface between eNB 205 and SGW 220. The S1-U interface may be implemented, for example, using a General Packet Radio Service (GPRS) Tunneling Protocol User Plane (GTPv2-U). In the exemplary configuration of FIG. 2, eNB 205 serves as a “master” node, while gNB 210 serves as a secondary node.

gNB 210 may include one or more devices and other components having functionality that allow end device 110 to wirelessly connect to 5G NR RAN 130-2. In one implementation, gNB 210 may support radio access technologies using millimeter wave frequency bands. gNB 210 may interface with SGW 220 of core network 140 via an S1-U interface. eNB 205 and gNB 210 may communicate with each other via an X2 interface. An X2 interface may be implemented, for example, with a protocol stack that includes an X2 application protocol and Stream Control Transmission Protocol (SCTP). As shown in FIG. 2, X2 interface may be divided into a control plane interface, X2-C, and a user plane interface, X2-U. X2-C interface may be used to coordinate uplink and downlink packet delivery for end device 110. X2-U interface may be used to route data packets for end device 110 between eNB 205 and gNB 210.

MME device 215 (also simply referred to as MME 215) may include a network device that implements control plane processing for core network 140. For example, MME 215 may implement tracking and paging procedures for end device 110, may activate and deactivate bearers for end device 110, may authenticate a user of end device 110, and may interface to non-LTE RANs, such as 5G NR RAN 130-2. MME 215 may also select a particular SGW 220 for end device 110. MME 215 may communicate with SGW 220 through an S11 interface. The S11 interface may be implemented, for example, using GTPv2. The S11 interface may be used to create and manage a new session for a particular end device 110.

SGW device 220 (also simply referred to as SGW 220) may provide an access point to and from end device 110, may handle forwarding of data packets for end device 110, and may act as a local anchor point during handover procedures between eNBs 205 and/or gNBs 210. SGW 220 may interface with PGW 230 through an S5/S8 interface. The S5/S8 interface may be implemented, for example, using GTPv2.

PGW device 230 (also simply referred to as PGW 230) includes a network or computational device that functions as a gateway to PDN 160. In one exemplary implementation, PGW 230 may be a traffic exit/entry point for core network 140. End device 110 may connect to PGW 230 via one or more tunnels established between gNB 210 and PGW 230, such as one or more GTP tunnels. End device 110 may simultaneously connect to more than one PGW for accessing multiple PDNs 160. PGW 230 may perform policy enforcement, packet filtering for each user, charging support, lawful intercept, and packet screening. PGW 230 may also act as an anchor for mobility between 3GPP and non-3GPP technologies.

HSS device 270 (also simply referred to as HSS 270) may store information associated with end device 110 and/or information associated with users/owners of end device 110. For example, HSS 270 may store user profiles, such as a Subscriber Profile Repository (SPR), that include authentication and access authorization information. As described further herein, the subscriber profiles may store use restrictions or bearer preferences for a particular end device 110, such as restricting a particular end device 110 to certain aggregated bandwidth limits over a dual-connectivity split bearer. HSS 270 may communicate with MME 215 through an S6a interface. The subscriber profile may also identify particular services to which a user of end device 110 has subscribed.

Although FIG. 2 shows exemplary components of network portion 200, in other implementations, network portion 200 may include fewer components, different components, differently-arranged components, or additional components than depicted in FIG. 2. Additionally or alternatively, one or more components of network portion 200 may perform functions described as being performed by one or more other components of network portion 200.

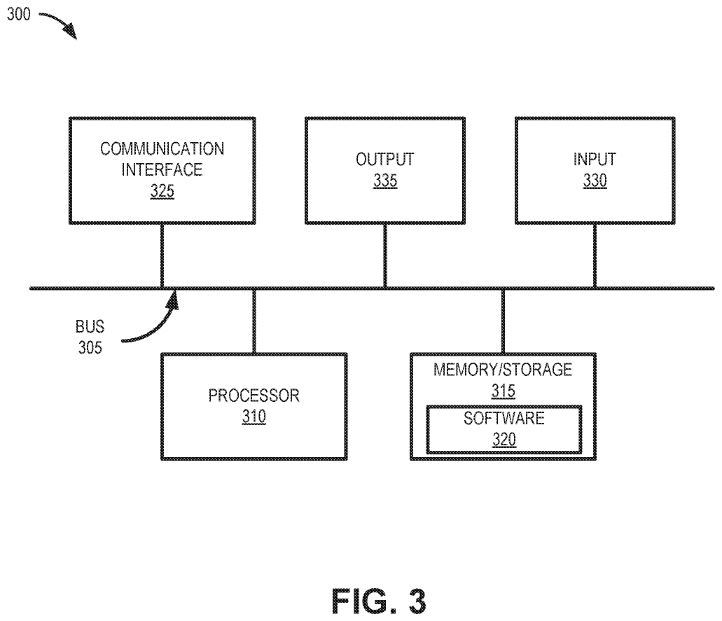

FIG. 3 is a diagram illustrating exemplary components of a device 300 that may correspond to one or more of the devices described herein. For example, device 300 may correspond to components included in end device 110, eNB 205, gNB 210, MME 215, SGW 220, PGW 230, and HSS 270. As illustrated in FIG. 3, according to an exemplary embodiment, device 300 includes a bus 305, a processor 310, a memory/storage 315 that stores software 320, a communication interface 325, an input 330, and an output 335. According to other embodiments, device 300 may include fewer components, additional components, different components, and/or a different arrangement of components than those illustrated in FIG. 3 and described herein.

Bus 305 includes a path that permits communication among the components of device 300. For example, bus 305 may include a system bus, an address bus, a data bus, and/or a control bus. Bus 305 may also include bus drivers, bus arbiters, bus interfaces, and/or clocks.

Processor 310 includes one or multiple processors, microprocessors, data processors, co-processors, application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, and/or some other type of component that interprets and/or executes instructions and/or data. Processor 310 may be implemented as hardware (e.g., a microprocessor, etc.), a combination of hardware and software (e.g., a SoC, an ASIC, etc.), may include one or multiple memories (e.g., cache, etc.), etc. Processor 310 may be a dedicated component or a non-dedicated component (e.g., a shared resource).

Processor 310 may control the overall operation or a portion of operation(s) performed by device 300. Processor 310 may perform one or multiple operations based on an operating system and/or various applications or computer programs (e.g., software 320). Processor 310 may access instructions from memory/storage 315, from other components of device 300, and/or from a source external to device 300 (e.g., a network, another device, etc.). Processor 310 may perform an operation and/or a process based on various techniques including, for example, multithreading, parallel processing, pipelining, interleaving, etc.

Memory/storage 315 includes one or multiple memories and/or one or multiple other types of storage mediums. For example, memory/storage 315 may include one or multiple types of memories, such as, random access memory (RAM), dynamic random access memory (DRAM), cache, read only memory (ROM), a programmable read only memory (PROM), a static random access memory (SRAM), a single in-line memory module (SIMM), a dual in-line memory module (DIMM), a flash memory (e.g., a NAND flash, a NOR flash, etc.), and/or some other type of memory. Memory/storage 315 may include a hard disk (e.g., a magnetic disk, an optical disk, a magneto-optic disk, a solid state disk, etc.), a Micro-Electromechanical System (MEMS)-based storage medium, and/or a nanotechnology-based storage medium. Memory/storage 315 may include a drive for reading from and writing to the storage medium.

Memory/storage 315 may be external to and/or removable from device 300, such as, for example, a Universal Serial Bus (USB) memory stick, a dongle, a hard disk, mass storage, off-line storage, network attached storage (NAS), or some other type of storing medium (e.g., a compact disk (CD), a digital versatile disk (DVD), a Blu-Ray disk (BD), etc.). Memory/storage 315 may store data, software, and/or instructions related to the operation of device 300.

Software 320 includes an application or a program that provides a function and/or a process. Software 320 may include an operating system. Software 320 is also intended to include firmware, middleware, microcode, hardware description language (HDL), and/or other forms of instruction. Additionally, for example, end device 110 may include logic to perform tasks, as described herein, based on software 320.

Communication interface 325 permits device 300 to communicate with other devices, networks, systems, devices, and/or the like. Communication interface 325 includes one or multiple wireless interfaces and/or wired interfaces. For example, communication interface 325 may include one or multiple transmitters and receivers, or transceivers. Communication interface 325 may include one or more antennas. For example, communication interface 325 may include an array of antennas. Communication interface 325 may operate according to a protocol stack and a communication standard. Communication interface 325 may include various processing logic or circuitry (e.g., multiplexing/de-multiplexing, filtering, amplifying, converting, error correction, etc.).

Input 330 permits an input into device 300. For example, input 330 may include a keyboard, a mouse, a display, a button, a switch, an input port, speech recognition logic, a biometric mechanism, a microphone, a visual and/or audio capturing device (e.g., a camera, etc.), and/or some other type of visual, auditory, tactile, etc., input component. Output 335 permits an output from device 300. For example, output 335 may include a speaker, a display, a light, an output port, and/or some other type of visual, auditory, tactile, etc., output component. According to some embodiments, input 330 and/or output 335 may be a device that is attachable to and removable from device 300.

Device 300 may perform a process and/or a function, as described herein, in response to processor 310 executing software 320 stored by memory/storage 315. By way of example, instructions may be read into memory/storage 315 from another memory/storage 315 (not shown) or read from another device (not shown) via communication interface 325. The instructions stored by memory/storage 315 cause processor 310 to perform a process described herein. Alternatively, for example, according to other implementations, device 300 performs a process described herein based on the execution of hardware (processor 310, etc.).

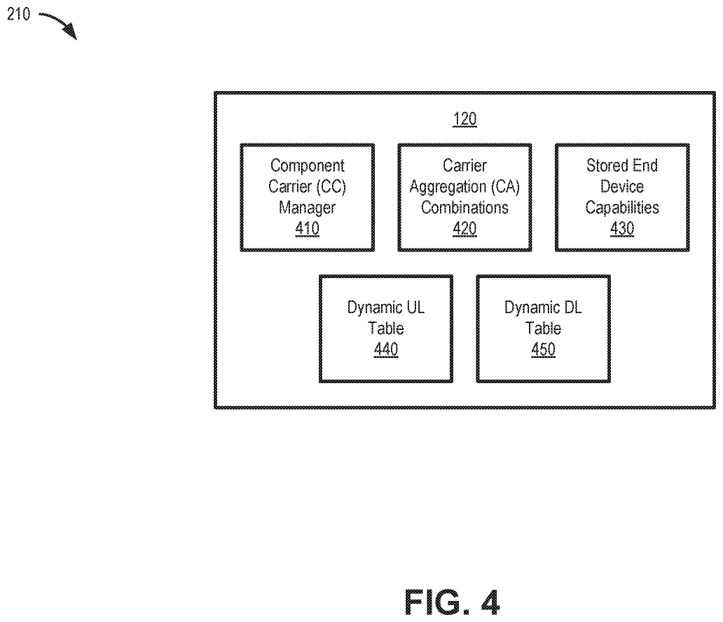

FIG. 4 is a block diagram illustrating logical components of a wireless station 120. The logical components of FIG. 4 may be implemented, for example, by processor 310 in conjunction with memory 315/software 320. As shown in FIG. 4, gNB 210 may include a carrier component (CC) manager 410; stored carrier aggregation (CA) combinations 420, stored end device capabilities 430, a dynamic uplink (UL) configuration (440), and a dynamic downlink (DL) configuration 450. The logical components of FIG. 4 are described below in the context of gNB 210. In other implementations, an eNB 205 (or another wireless station 120) may include similar logical components.

CC manager 410 may identify an end device buffer size for a particular service requirement and select a corresponding carrier aggregation combination to most efficiently support the data flow. For UL transmissions, gNB 210 may receive a UE buffer size from end device 110. For DL transmissions, gNB 210 may select the appropriate UE buffer size based on, for example, the flow properties of a stream or download. The UE buffer size may be provided to gNB 210, for example, as part of an RRC process. In one implementation, the end device buffer size may correspond to a Transmission Control Protocol (TCP)/Internet Protocol (IP) buffer. Using carrier aggregation combinations 420, CC manager 410 may apply the UL UE buffer size to select the closest CA combination for the current session, as described herein. Similarly, CC manager 410 may apply the DL UE buffer size to stored CA combinations 420 to select the closest CA combination for the current session, as described herein.

Carrier aggregation combinations 420 may include a data structure (e.g., a table, database, flat file, etc.) with a list of available CA combinations for a particular gNB 210. For example, carrier aggregation combinations 420 may include a preconfigured list of carrier aggregation combinations, and corresponding end device buffer sizes, available to end devices 110 that are connected to gNB 210. Carrier aggregation combinations 420 may include component carriers of different RAT types (e.g., component carriers for 5G NR RAN 130-2 and E-UTRAN 130-1). In one implementation, CC manager 410 may dynamically update carrier aggregation combinations 420 to track available component carriers and/or combinations that can be assigned to an end device (e.g., end device 110). For example, previous assignment of one carrier aggregation combination may preclude assignment of a different carrier aggregation combination that includes one of the same component carriers. Thus, when selecting an optimal combination from carrier aggregation combinations 420, CC manager 410 may select a carrier aggregation combination for a particular end device that exceeds the smallest (e.g., lowest bandwidth) predefined carrier aggregation combination for the identified buffer size when the required component carriers are not available (or are not supported by the end device).

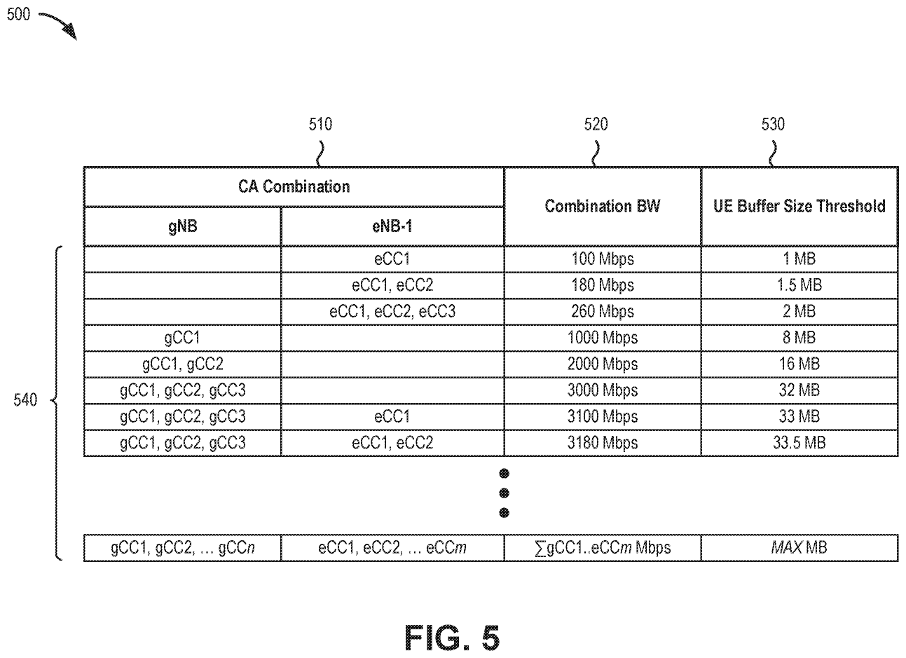

FIG. 5 is a diagram illustrating a portion 500 of carrier aggregation combinations 420. Portion 500 may represent values for DL carrier aggregation assignments. A similar data structure (e.g., with different component carriers and different values) may be used for UL carrier aggregation assignments. As shown in FIG. 5, stored CA combinations 420 may include a CA combination field 510, a combination bandwidth field 520, and a UE buffer size threshold field 530, and a variety of entries 540 for fields 510-530. Values of entries 540 in combination bandwidth field 520 and UE buffer size threshold field 530 are illustrative and may not reflect actual values.

CA combination field 510 may include different combinations of component carriers that may be assigned to end devices 110 (e.g., any end devices that are connected to gNB 210 with dual-connectivity to eNB 205). Entries 540 of CA combination field 510 may include different combinations of component carriers for each RAT-type. Combinations in CA combination field 510 may include, for example, as few as one component carrier an as many as the highest number of component carriers that can be supported by an end device.

Combination bandwidth field 520 may represent the total bandwidth supported by a particular CA combination from CA combination field 510. Each combination may provide a combined bandwidth value (in some instances, although not shown, different combinations of component carriers may have the same bandwidth value). For example, in portion 500, a single component carrier for an eNB 205 (e.g., eCC1) with no gNB component carrier may represent a lowest bandwidth option (e.g., 100 Mbps). As another example in portion 500, multiple component carriers for gNB 210 (e.g., gCC1, gCC2, gCC3) may be combined with one or more component carriers for eNB 201 (e.g., eCC1, eCC2) to provide much higher bandwidth (e.g., 3180 Mbps).

UE buffer size threshold field 530 may provide a value, range, or threshold that allows an end device buffer size to be associated with or correlated to an entry from CA combination field 510. For example, entries 540 in UE buffer size threshold field 530 may provide an upper limit for a particular buffer size that can be supported by a particular CA combination from CA combination field 510. As another example, entries 540 in UE buffer size threshold field 530 may include a range of values (e.g., a high and low buffer size value). In one implementation, entries for UE buffer size threshold field 530 may be predetermined values that are calculated based on accepted latency and performance criteria for different applications. That is, a particular combination in CA combination field 510 (e.g., gGG1, gCC2, gCC3, and eCC1) may correspond to a particular bandwidth value in bandwidth field 520 (e.g., 3100 Mbps), which may correspond to a particular value in UE buffer size threshold field 530 (e.g., 33 MB). In one implementation, different buffer sizes may correspond to different video/multimedia stream qualities, where larger buffer sizes are indicative of higher bandwidth requirements. In another implementation, values for UE buffer size threshold field 530 may be determined empirically.

Portion 500 is an illustration of one form of stored CA combinations 420 that may be used by gNB 210. In other implementations, fewer, different, or additional fields may be included in CA combinations 420. For example, combination bandwidth field 520 may not be included in CA combinations 420. As another example, additional fields may be used to dynamically track availability of different entries 540 in CA combinations 420. The number of component carriers, the available CA combinations, the bandwidth values for CA combination, and the corresponding UE buffer size for each CA combination may differ in other implementations. Furthermore, in other implementations, stored CA combinations 420 may include component carriers for more than two RANs. In still other implementations, separate data structures with different values may be used for different applications and/or end device types.

Returning to FIG. 4, stored end device capabilities 430 may include a data structure that indicates end device 110 capabilities, such as supported carrier aggregations band and the number of supported component carriers, for connected end devices 110. In one implementation, stored end device capabilities 430 may be populated based on UE capability information received as part of an RRC message exchange. In another implementation, UE capability information may be stored for particular end device types, and component carrier manager 410 may associate an end device type (e.g., as indicated in a connection request) with stored capabilities in stored end device capabilities 430. Component carrier manager 410 may refer to information in stored end device capabilities 430 to ensure that a particular CA combination selected from stored CA combinations 420 will not exceed capabilities of end device 110.

Dynamic UL table 440 may track UL component carrier combinations assigned to each end device 110. Dynamic DL table 450 may track DL component carrier combinations assigned to each end device 110. Dynamic UL table 440 and dynamic DL table 450 may include separate data structures (e.g., a table, database, flat file, etc.) or a combined data structure. Component carrier manager 410 may update dynamic UL table 440 and dynamic DL table 450 in real time to reflect CA combinations assigned to each end device 110 to duplicative assignments. In one implementation, component carrier manager 410 may refer to information in dynamic UL table 440 and/or dynamic DL table 450 to ensure that a particular CA combination selected from stored CA combinations 420 are valid/available. In another implementation, stored CA combinations 420, dynamic UL table 440, and dynamic DL table 450 may be applied as a single dynamic data structure.

Although FIG. 4 show exemplary logical components of wireless station 120, in other implementations, wireless station 120 may include fewer logical components, different logical components, or additional logical components than depicted in FIG. 4. Additionally or alternatively, one or more logical components of wireless station 120 may perform functions described as being performed by one or more other logical components.

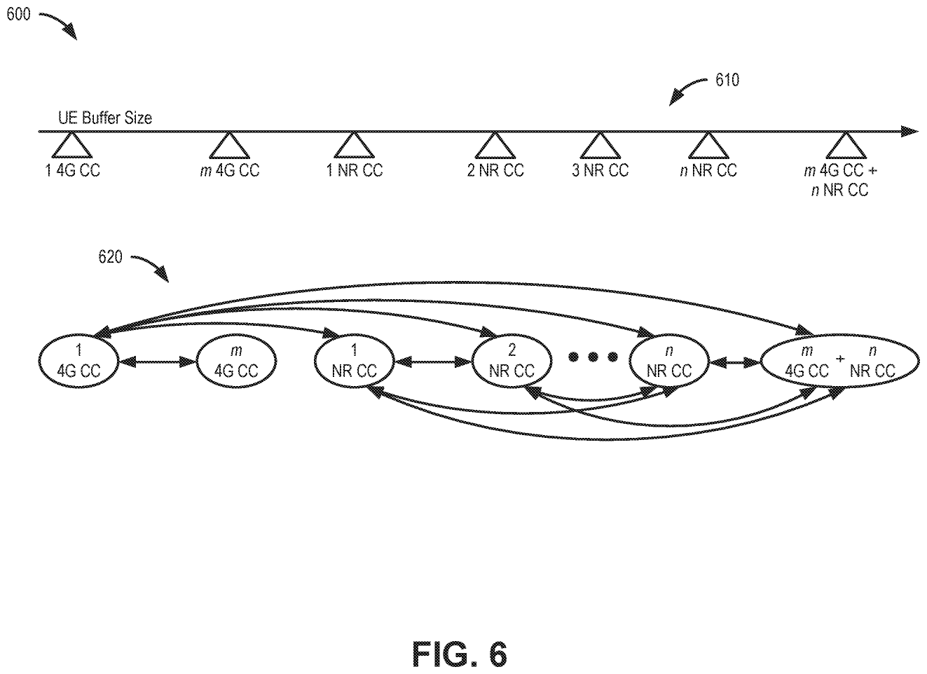

FIG. 6 is a logic chart showing an example of how CA combinations may be assigned by wireless station 120 in one implementation. Generally, 4G component carriers (4G CC) may be assumed to have a much smaller maximum bandwidth (e.g., about one-tenth or less) than that of 5G NR component carriers (NR CC). As shown in FIG. 6, component carriers may be assigned based on a DL or UL UE buffer size for end device 110. Referring to chart portion 610, generally as the UE buffer size increases, the bandwidth capacity of the carrier aggregation combinations will also increase. In one implementation, carrier aggregation combinations may be selected from a preconfigured order to minimize power consumption by end device 110 while meeting data flow requirements or other service requirements. In one implementation, the preconfigured order may be incorporated into stored CA combinations 420. In another implementation, the preconfigured order may be incorporated into stored end device capabilities 430 in which a power-saving profile of end device 110 may serve as a basis to select an optimal order that minimizes power consumption. Wireless station 120 (e.g., component carrier manager 410) may use the preconfigured order to assign a carrier aggregation combination to end device 110 by correlating a given UE buffer size to the closest UE buffer size threshold (e.g., from UE buffer size threshold field 530) and selecting a corresponding carrier aggregation combination from carrier aggregation combination field 510).

Referring to chart portion 620, 4G component carriers (e.g., one 4G CC up to m 4G CCs, where m represents the maximum number of 4G component carriers supported by end device 110 and m is presumably less than 10 or another value) may be assigned for the lowest UE buffer sizes. If the UE buffer size exceeds the capacity for m 4G CCs, one or more 5G NR component carriers (e.g., one NR CC up to n NR CCs, where n represents the maximum number of 5G NR component carriers supported by end device 110) may be assigned for increasingly larger UE buffer sizes, without additional 4G component carriers. If the UE buffer size exceeds the capacity for n NR CCs, additional 4G component carriers (e.g., up to m 4G CCs) may be added to the 5G NR component carriers for maximum capacity.

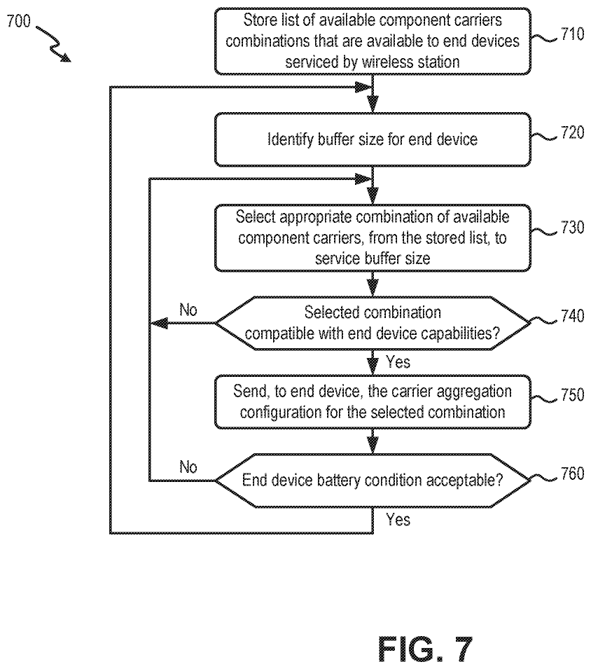

FIG. 7 is a flow diagram illustrating an exemplary process 700 for optimizing carrier aggregation over a dual-connectivity bearer, according to an implementation described herein. In one implementation, process 700 may be implemented by gNB 210. In another implementation, process 700 may be implemented by another wireless station 120 and/or in conjunction with one or more other devices in network environment 100.

Referring to FIG. 7, process 700 may include storing a list of available component carrier combinations that are available to end devices serviced by a wireless station (block 710). For example, wireless station 120 may receive CA combinations 420 and store CA combinations in a local memory of wireless station 120. As described above, CA combinations 420 may include different combinations of component carriers from different RAT types that may be combined in a preconfigured order to minimize power consumption by end devices while meeting data flow requirements.

Process 700 may also include identifying a buffer size for an end device (block 720) and selecting an appropriate combination of available component carriers, from the stored list, to service the identified buffer size (block 730). For example, as part of signaling for an RRC connection procedure wireless station 120 may receive an uplink UE buffer size from end device 110 and may select a downlink buffer size for end device 110 for given flow characteristics. With the identified uplink or downlink buffer size, wireless station 120 (e.g., component carrier manager 410) may use the locally-stored CA combinations 420 to identify a UE buffer size threshold (e.g., from a UE buffer size threshold field 530) and a corresponding CA combination (e.g., from CA combination field 510).

Process 700 may further include determining if the selected combination is compatible with the end device capabilities (block 740). For example, wireless station 120 (e.g., component carrier manager 410) may obtain (e.g., from stored end device capabilities 430 or from RCC Connection signaling) end device 110 capabilities including bandwidths supported by the end device and a number of carrier components supported for each RAT type (e.g., 4G, 5G NR, etc.). Wireless station 120 may compare the selected CA combination from CA combinations 420 with the capabilities of end device 110 to determine if end device 110 can support the selected CA combination. If the selected combination is not compatible with the end device capabilities (block 740—No), process 700 may return to block 730 to select another appropriate combination of available component carriers to service the identified buffer size.

If the selected combination is compatible with the end device capabilities (block 740—Yes), process 700 may additionally include sending, to the end device, the carrier aggregation configuration for the selected combination (block 750). For example, in one implementation, wireless station 120 may transmit an RRC Connection Setup message associated with a first RAT, which includes signaling radio bearer (SRB) configuration information pertaining to one or multiple other RATs (e.g., a second RAT, etc.). The SRB configuration information may be carried in an information element (IE) of the RRC Connection Setup message and may identify the combination of component carriers to be used by the end device.

Process 700 may further include detecting if the battery condition of the end device is acceptable (block 760). For example, wireless station 120 may receive a signal from end device 110 if a battery (or other power source for end device 110) is low or overheating. In one implementation, a low battery indication may be based on a configurable threshold. If the battery condition of the end device is not acceptable (block 760—No), process 700 may return to block 730 to select another appropriate (e.g., lower bandwidth) combination of available component carriers. If the battery condition of the end device is acceptable (block 760—Yes), process 700 may return to block 720 to identify a buffer size for an end device. For example, a new connection request may be received from end device 110 which alters the buffer size for the end device and triggers selection of a new CA combination. Thus, when the buffer size changes, the RAN (e.g., wireless station 120) will adjust the optimal CA combination for end device 110.

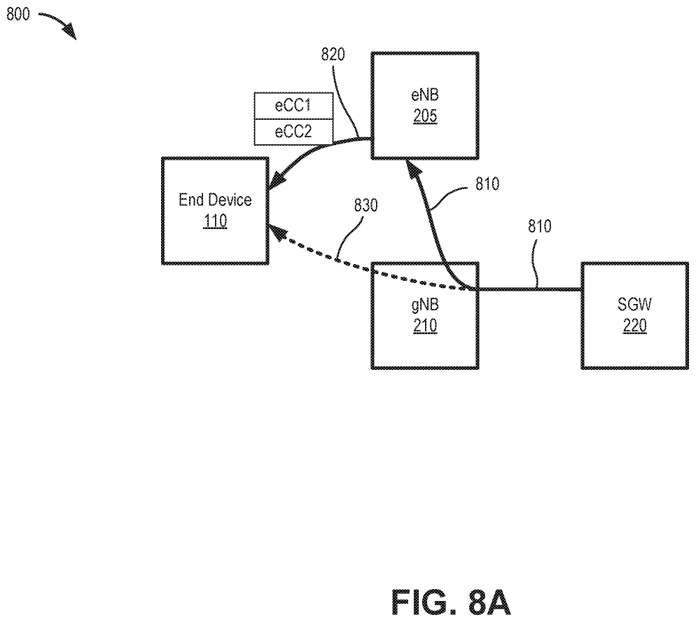

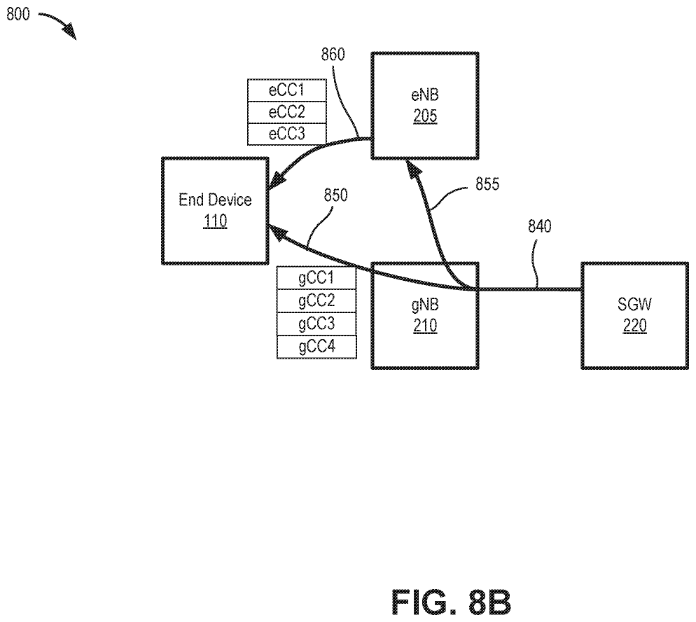

FIGS. 8A and 8B are a diagram illustrating exemplary communications for managing carrier aggregation for an EN-DC environment in a portion 800 of network environment 100. Network portion 700 may include end device 110, eNB 205, gNB 210, and SGW 220. More specifically, FIG. 8A is a diagram illustrating an exemplary downlink path for a lower-bandwidth flow, and FIG. 8B is a diagram illustrating an exemplary downlink path for a comparatively higher-bandwidth flow. Although not shown, carrier aggregation for uplink communications may be implemented in a similar manner.

Referring to FIG. 8A, gNB 120 may configure a DL flow path 810 to end device 110 based on a relatively small buffer size requirement for end device 110. Even though dual connectivity with eNB 205 and gNB 210 is available for end device 110, gNB 210 may assign (e.g., using SRB configuration information) downlink flow 810 through two component carriers for eNB 205 (i.e., eCC1 and eCC2). Once assigned, gNB 210 may route downlink packets for flow 810 from SGW 220 to eNB 205 (e.g., via an X2-U interface), and eNB 205 may transmit data packets to end device 110 via eCC1 and eCC2 using carrier aggregation. Available carrier components over the higher-bandwidth (and high power consumption) NR connection 830 would not be utilized.

Referring to FIG. 8B, gNB 120 may configure another DL flow path to end device 110 based on a relatively large buffer size requirement for end device 110. Using dual connectivity with eNB 205 and gNB 210, gNB 210 may assign (e.g., using SRB configuration information) a first portion of downlink flow 840 through all available component carriers 850 for gNB 210 (i.e., gCC1, gCC2, gCC3, and gCC4, up to the full capacity of end device 120) and a remaining portion 855 of downlink flow 840 through two component carriers 860 for eNB 205 (i.e., eCC1 and eCC2). Once the component carriers are assigned over both RAT types (e.g., 4G RAN and 5G NR RAN), gNB 210 may route most of the downlink packets for flow 840 over component carriers 850 (i.e., gCC1, gCC2, gCC3, and gCC4) and route the remaining downlink packets (e.g., portion 855) for downlink flow 840 to eNB 205 (e.g., via the X2-U interface). eNB 205 may transmit data packets for portion 855 to end device 110 via component carriers 860 (e.g., eCC1 and eCC2). Using carrier aggregation, end device 110 may assembly data from component carriers 850 and component carriers 860 for consumption.

Systems and methods described herein enable optimizing carrier aggregation over a dual-connectivity bearer. The systems and methods select an optimal combination of E-UTRAN and/or 5G NR RAN component carriers based on the end device buffer size associated with a service request. The systems and methods automatically select the least power-consuming (e.g., for the end device) combination of component carriers and RAT types to fully satisfy a service requirement when in a dual connectivity environment. Carrier aggregation combinations may be selected initially by the wireless station without the latency of “ramping up” to a maximum bandwidth or “ramping down” to a minimum bandwidth when adding/removing component carriers one-by-one.

The foregoing description of implementations provides illustration and description, but is not intended to be exhaustive or to limit the invention to the precise form disclosed. Modifications and variations are possible in light of the above teachings or may be acquired from practice of the invention. For example, while a series of blocks have been described with regard to FIG. 7, the order of the blocks and message/operation flows may be modified in other embodiments. Further, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

To the extent the aforementioned embodiments collect, store, or employ personal information of individuals, it should be understood that such information shall be collected, stored, and used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A wireless station, comprising:
a first communications interface for sending or receiving packets using a wireless access network;
a second communications interface for sending or receiving packets via another wireless station;
one or more memories to store instructions; and
one or more processors configured to execute the instructions to:
determine a buffer size for an end device connected to the wireless station via the first communication interface;
determine, for the end device and based on the buffer size, an optimal carrier aggregation combination to satisfy a service requirement for the end device, wherein the optimal carrier aggregation combination is selected from a dynamic list of component carriers for different radio access technology (RAT) types that are available to end devices serviced by the wireless station; and
send, to the end device, instructions to implement the carrier aggregation combination.

2. The wireless station of claim 1, wherein the one or more processors are further configured to execute the instructions to:
store, in the memory, a dynamic list of component carriers that are available to end devices serviced by the wireless station, wherein the list of component carriers includes:
different combinations of component carriers for multiple RAT types, and
buffer size values associated with the different component carrier combinations.

3. The wireless station of claim 2, wherein, when determining the optimal carrier aggregation combination, the one or more processors are further configured to execute the instructions to:
correlate the end device buffer size to a closest one of the buffer size values that corresponds to a smallest available uplink or downlink bandwidth that satisfies the service requirement.

4. The wireless station of claim 3, wherein the different combinations of component carriers provide different corresponding bandwidths to the end device.

5. The wireless station of claim 1, wherein the second communication interface includes an X2-U interface and the other wireless station includes an eNodeB.

6. The wireless station of claim 1, wherein the list of component carriers includes different combinations of Evolved Universal Mobile Telecommunications System (UMTS) Terrestrial Radio Access (E-UTRA) component carriers and Fifth Generation New Radio (5G NR) component carriers.

7. The wireless station of claim 1, wherein the wireless station uses radio access technology that supports one or more millimeter wave frequency bands.

8. The wireless station of claim 1, wherein the one or more processors are further configured to execute the instructions to:
select, for the end device, another carrier aggregation combination when the end device indicates a poor battery condition, wherein the other carrier aggregation combination provides a lower bandwidth than the carrier aggregation combination that was previously selected.

9. The wireless station of claim 1, wherein the one or more processors are further configured to execute the instructions to:
provide downlink packets to the end device using the first communication interface for a Fifth Generation New Radio (5G NR) radio access network (RAN); and
provide other of downlink packets to the end device using the second communication interface to an evolved Node B (eNB) for an Evolved UMTS Terrestrial Radio Access Network (E-UTRAN).

10. The wireless station of claim 1, wherein the one or more processors are further configured to execute the instructions to:
verify that the end device is capable of supporting the selected carrier aggregation combination before sending the instructions to implement the carrier aggregation combination.

11. A method performed by a wireless station, the method comprising:
determining a buffer size for an end device connected to the wireless station via a wireless communication interface;
determining, for the end device and based on the buffer size, an optimal carrier aggregation combination to satisfy a service requirement for the end device, wherein the optimal carrier aggregation combination is selected from a dynamic list of component carriers for different radio access technology (RAT) types that are available to end devices serviced by the wireless station; and
sending, to the end device, instructions to implement the carrier aggregation combination.

12. The method of claim 11, wherein the different RAT types include an Evolved UMTS Terrestrial Radio Access Network (E-UTRAN) and a Fifth Generation New Radio (5G NR) radio access network (RAN).

13. The method of claim 11, wherein determining the buffer size for the end device includes determining a downlink buffer size responsive to a service request.

14. The method of claim 13, wherein the downlink buffer size is for a Transmission Control Protocol (TCP)/Internet Protocol (IP) buffer.

15. The method of claim 11, wherein determining the optimal carrier aggregation combination further includes:
determining that the end device supports use of an amount of component carriers in the carrier aggregation combination.

16. The method of claim 15, wherein determining the optimal carrier aggregation combination further includes:
determining that the end device is equipped to use multi-RAT dual connectivity for each frequency used in the carrier aggregation combination.

17. The method of claim 11, further comprising:
identifying an updated buffer size for the end device; and
selecting for the end device, and in response to the identifying, another carrier aggregation combination based on the updated buffer size.

18. The method of claim 11, further comprising:
storing, in a local memory, the dynamic list of component carriers that are available to end devices serviced by the wireless station, wherein the dynamic list of component carriers includes:
different combinations of component carriers for multiple RAT types, and
buffer size values associated with the different component carrier combinations.

19. A non-transitory computer-readable medium containing instructions executable by at least one processor, the computer-readable medium comprising one or more instructions to cause the at least one processor to:
determine a buffer size for an end device connected to a wireless station via a wireless communication interface;
determine, for the end device and based on the buffer size, an optimal carrier aggregation combination to satisfy a service requirement for the end device, wherein the optimal carrier aggregation combination is selected from a dynamic list of component carriers for different radio access technology (RAT) types that are available to end devices serviced by the wireless station; and
send, to the end device, instructions to implement the carrier aggregation combination.

20. The non-transitory computer-readable medium of claim 19, further comprising instructions to cause the at least one processor to:
identify an updated buffer size for the end device; and
select for the end device, and in response to the identifying, another carrier aggregation combination based on the updated buffer size.
